(19) United States
(12) Patent Application Publication
(10) Pub. No.: US 2014/0281794 A1
(43) Pub. Date: Sep. 18, 2014

(54) ERROR CORRECTION CIRCUIT

(71) Applicant: KABUSHIKI KAISHA TOSHIBA, Minato-ku (JP)

(72) Inventor: Kenji SAKAUE, Yokohama-shi (JP)

(73) Assignee: KABUSHIKI KAISHA TOSHIBA, Minato-ku (JP)

(21) Appl. No.: 13/963,125

(22) Filed: Aug. 9, 2013

Related U.S. Application Data
(60) Provisional application No. 61/782,919, filed on Mar. 14, 2013.

(51) Int. Cl. G06F 11/10

(52) U.S. Cl. CPC G06F 11/1008
USPC 714/758

(57) ABSTRACT

According to one embodiment, an error correction circuit includes a first memory module, a read-out module, a first arithmetic module, a detector, a second arithmetic module, and a transfer module. The first memory module stores logarithmic likelihood ratio (LLR) data to which low density parity check codes (LDPC) data has been converted. The read-out module reads out, from the first memory module, the LLR data of a plurality of variable nodes which are connected to a selected check node, based on a check matrix. The first and second arithmetic modules update the LLR data, based on the read-out LLR data and first and second reliability data. The transfer module transfers the updated LLR data to the first memory module.

### CROSS-REFERENCE TO RELATED APPLICATIONS

This application claims the benefit of U.S. Provisional Application No. 61/782,919, filed Mar. 14, 2013, the entire contents of which are incorporated herein by reference.

### FIELD

Embodiments described herein relate generally to an error correction circuit of an error correction circuit of a nonvolatile semiconductor memory device, for example, a NAND flash memory.

### BACKGROUND

For example, as a NAND flash memory, a multilevel NAND flash memory, which can store data of a plurality of bits in one memory cell, has been developed with an increase in storage capacity. In addition, in accordance with an increase in storage capacity, a data error correction technique for the NAND flash memory has become important.

### BRIEF DESCRIPTION OF THE DRAWINGS

FIG. 1 is a view for describing a basic operation of LDPC.

FIG. 2 is a view for describing a basic operation of LDPC.

FIG. 3A and FIG. 3B are views illustrating an example of a check matrix.

FIG. 4A and FIG. 4B are views for explaining the check matrix.

FIG. 5A, FIG. 5B and FIG. 5C are views illustrating an example of a process of a TMEM variable.

FIG. 6 is a view illustrating an example of the configuration of an LDPC decoder.

FIG. 7 is a flowchart illustrating an operation of the LDPC decoder shown in FIG. 6.

FIG. 8 is a view illustrating an example of the procedure for updating logarithmic likelihood ratios (LLRs) of variable nodes (vn).

FIG. 9 is a flowchart illustrating an operation of a first embodiment.

FIG. 10 is a view which schematically illustrates a bit node memory module (LMEM) according to the first embodiment.

FIG. 11 is a view which schematically illustrates the structure of an LDPC decoder according to the first embodiment.

FIG. 12 is a view illustrating a concrete structure of the LDPC decoder shown in FIG. 11.

FIG. 13 is a view illustrating an operation of the LDPC decoder shown in FIG. 12.

FIG. 14 is a view which schematically illustrates the structure of an LDPC decoder according to a second embodiment.

FIG. 15 is a view illustrating an operation of the LDPC decoder shown in FIG. 14.

FIG. 16 is a view illustrating an example of a check matrix according to a third embodiment.

FIG. 17 is a view for explaining a control between row processes using the check matrix shown in FIG. 16.

FIG. 18 is a view for explaining another control between row processes using the check matrix shown in FIG. 16.

FIG. 19 is a view illustrating another example of the check matrix according to the third embodiment.

FIG. 20 is a view for explaining a control between row processes using the check matrix shown in FIG. 19.

FIG. 21 is a view illustrating an example of the structure of an LDPC decoder according to a fourth embodiment.

FIG. 22 is a view illustrating an example of a check matrix according to the fourth embodiment.

FIG. 23 is a flowchart illustrating an operation of the fourth embodiment.

FIG. 24 is a flowchart illustrating an operation of a modification of the fourth embodiment.

### DETAILED DESCRIPTION

In general, according to one embodiment, an error correction circuit includes a first memory module, a read-out module, a first arithmetic module, a first register, a detector, a second arithmetic module, and a transfer module. The first memory module is configured to store logarithmic likelihood ratio data to which low density parity check codes (LDPC) data has been converted. The read-out module is configured to read out, from the first memory module, the logarithmic likelihood ratio data of a plurality of variable nodes which are connected to a selected check node, based on a check matrix. The first arithmetic module is configured to calculate a plurality of second reliability data, based on the logarithmic likelihood ratio data, which is read out of the first memory module, of the plurality of variable nodes connected to the selected check node, and first reliability data. The first register is configured to store the plurality of second reliability data. The detector is configured to detect a minimum value of the plurality of second reliability data stored in the first register. The second arithmetic module is configured to execute an arithmetic operation of the second reliability data and the minimum value which is output from the detector, and to output an arithmetic result as the logarithmic likelihood ratio data which has been updated. The transfer module is configured to transfer the updated logarithmic likelihood ratio data, which is supplied from the second arithmetic module, to the first memory module.

For example, a NAND flash memory includes a low density parity check codes (LDPC) decoder for error correction. The LDPC decoder has such a feature that a decoding capability is improved in proportion to an increase in code length. Thus, the code length of the LDPC, which are used in, for example, a NAND flash memory, is on the order of, e.g. 10 Kbits.

Referring to FIG. 1 to FIG. 5C, the basic operation of the LDPC is explained.

### (LDPC Codes and Partial Parallel Processing)

To begin with, a description is given of LDPC codes and partial parallel processing in an embodiment. LDPC codes are linear codes which are defined by a very sparse check matrix, that is, a check matrix including a small number of non-zero elements in the matrix, and can be represented by a Tanner graph. An error correction process corresponds to updating by exchanging locally estimated results between bit nodes (also referred to as “variable nodes vn”), which correspond to bits of a code word, and check nodes corresponding to respective parity check formulae, the bit nodes and the check nodes being connected on the Tanner graph.

FIG. 1 shows a check matrix H1 with a row weight wr=3 and a column weight wc=2 in (6, 2) LDPC codes. The (6, 2) LDPC codes are LDPC codes with a code length of 6 bits and an information length of 2 bits.

As illustrated in FIG. 2, if the check matrix H1 is represented by a Tanner graph G1, bit notes correspond to columns of a check matrix H, and check nodes correspond to rows of the check matrix H. Of the elements of the check matrix H1, nodes of “1” are connected by edges, whereby the Tanner graph G1 is formed. For example, “1”, which is encircled at a second row and a fifth column of the check matrix H1, corresponds to an edge which is indicated by a thick line in the Tanner graph G1. In addition, the row weight wr=3 of the check matrix H1 corresponds to the number of bit nodes which are connected to one check node, namely an edge number “3”, and the column weight wc=2 of the check matrix H1 corresponds to the number of check nodes which are connected to one bit node, namely an edge number “2”.

Decoding of LDPC encoded data is executed by repeatedly updating reliability (probability) information, which is allocated to the edges of the Tanner graph, at the nodes. The reliability information is classified into two kinds, i.e. probability information from a check node to a bit node (hereinafter also referred to as “external value” or “external information”, and expressed by symbol “α”), and probability information from a bit node to a check node (hereinafter also referred to as “prior probability”, “posterior probability”, or simply “probability”, or “logarithmic likelihood ratio (LLR)”, and expressed by symbol “β” or “λ”). The reliability update process comprises a row process and a column process. A unit of execution of a single row process and a single column process is referred to as “1 iteration (round) process”, and a decoding process is executed by a repetitive process in which the iteration process is repeated.

As described above, the external value α is the probability information from the check node to the bit node at a time of the LDPC decoding process, and the probability β is the probability information from the bit node to the check node. These terms are well known to a person skilled in the art.

In a semiconductor memory device, threshold determination information is read out from a memory cell which stores encoded data. The threshold determination information comprises a hard bit (HB) which indicates whether the stored data is “0” or “1”, and a plurality of soft bits (SB) which indicate the likelihood of the hard bit. The threshold determination information is converted to an LLR by an LLR table which is prepared in advance, and becomes an initial LLR of the iteration process.

A decoding process by parallel processing can be executed in a reliability update algorithm (decoding algorithm) at bit nodes and check nodes, with use of a sum product algorithm or a mini-sum product algorithm.

However, in the case of LDPC encoded data with a large code length, a complete parallel processing, in which all processes are executed in parallel, is not practical since many arithmetic circuits need to be mounted.

By contrast, if a check matrix, which is formed by combining a plurality of unit matrices (hereinafter also referred to as “blocks”), is used, the circuit scale can be reduced by executing partial parallel processing by arithmetic circuits corresponding to a bit node number p of a block size p.

FIG. 3A shows a check matrix H3 which is composed by combining a plurality of unit matrices. The check matrix H3 comprises 15 rows in the vertical direction and 30 columns in the horizontal direction, by arranging 6 blocks, each comprising 5×5 elements, in the horizontal direction and three blocks in the vertical direction.

As illustrated in FIG. 3B, each of blocks B of the check matrix H3 is a square matrix (hereinafter referred to as “shift matrix”), wherein a unit matrix including 1's arranged in diagonal components and 0's in the other components is shifted by a degree corresponding to a numerical value. Incidentally, the check matrix H3 shown in FIG. 3A is composed of an encode-target (message) block section H3A, which is blocks for user data, and a parity block section H3B for parity, which is generated from user data.

As shown in FIG. 3B, a shift value “0” indicates a unit matrix, and a shift value “−1” indicates a 0 matrix. Incidentally, since the 0 matrix requires no actual arithmetic process, a description of the 0 matrix is omitted in the description below.

A bit, which has been shifted out of a block by a shift process, is inserted in a leftmost column in the block. In the decoding process using the check matrix H3, necessary block information, that is, information of nodes to be processed, can be obtained by designating shift values. In the meantime, in the check matrix H3 comprising blocks each with 5×5 elements, the shift value is any one of 0, 1, 2, 3 and 4, except for the 0 matrix which has no direct relation to the decoding process.

In the case of using the check matrix H3 in which square matrices each having a block size 5×5 (hereinafter referred to as “block size 5”) shown in FIG. 3A are combined, five arithmetic units are provided in an arithmetic module 113, and thereby partial parallel processing can be executed for the five check nodes. In the meantime, in order to execute the partial parallel processing, a bit node memory module (LMEM) 112, which stores a variable (hereinafter referred to as “LMEM variable” or “LLR”) for finding a prior/posterior probability β in units of a bit node, and a check node memory module (TMEM) 114, which stores a variable (hereinafter referred to as “TMEM variable”) for finding an external value α in units of a check node, are necessary. Since the bit nodes are managed by column-directional addresses (column addresses), the LMEM is managed by column addresses. Since the check nodes are managed by row-directional addresses (row addresses), the TMEM is managed by row addresses. When the external value α and the probability β are calculated, the LMEM variable, which is read from the LMEM, and the TMEM variable, which is read from the TMEM, are delivered to the arithmetic circuits, and are subjected to arithmetic processes.

When decoding is executed by using the check matrix H3 which is formed by combining a plurality of unit matrices, if plural TMEM variables, which are read from the TMEM, are rotated by a rotater 113A in accordance with shift values, there is no need to store the entirety of the check matrix H3.

For example, as illustrated in FIGS. 4A and 4B and FIGS. 5A, 5B and 5C, a process of eight TMEM variables which are read from the TMEM 114 is executed by using a check matrix H4 of a block size 8, use is made of a memory controller 103 including the LMEM 112, TMEM 114, arithmetic module 113 and rotater 113A. The arithmetic module 113 comprises eight arithmetic circuits ALU0 to ALU7, and eight processes can be executed in parallel. Incidentally, the shift values in the case of using the check matrix H3 of the block size 8 are eight kinds, i.e. 0 to 7.

As illustrated in FIG. 4A and FIG. 5A, in the case of a block B(0) with a shift value “0”, a rotate process of a rotate value “0” is executed by the rotater 113A, and an arithmetic operation is performed between variables of the same address. It should be noted, however, that the rotate process with rotate value “0” means that no rotation is executed.

LMEM variable of column address 0, TMEM variable

of row address 0 (indicated by a broken line in
FIG. 4A);

LMEM variable of column address 1, TMEM variable

of row address 1;

LMEM variable of column address 2, TMEM variable

of row address 2;

.
.

LMEM variable of column address 7, TMEM variable

of row address 7 (indicated by a broken line in
FIG. 4A).

On the other hand, as shown in FIG. 4B and FIG. 5B, in the case of a block B(1) with a shift value “1”, a rotate process of a rotate value “1” is executed by the rotater 113A, and an arithmetic operation is performed between variables as described below. Specifically, the rotate process with rotate value “1” is a shift process in which each variable is shifted to the right by one, and the variable of the lowermost row, which has been shifted out of the block, is inserted in the lowermost row on the left side.

LMEM variable of column address 0, TMEM variable

of row address 7 (indicated by a broken line in
FIG. 4B);

LMEM variable of column address 1, TMEM variable

of row address 0 (indicated by a broken line in
FIG. 4B);

LMEM variable of column address 2, TMEM variable

of row address 1;

.
.

LMEM variable of column address 7, TMEM variable

of row address 6.

As illustrated in FIG. 5C, in the case of a block B(7) with a shift value “7”, a rotate process of a rotate value “7” is executed by the rotater 113A, and an arithmetic operation is performed between variables as described below. Specifically, the rotate process with rotate value “7” is a shift process in which a rotate process with rotate value “1” is executed seven times.

LMEM variable of column address 0, TMEM variable

of row address 1;

LMEM variable of column address 1, TMEM variable

of row address 2;

LMEM variable of column address 2, TMEM variable

of row address 3;

.
.

LMEM variable of column address 7, TMEM variable

of row address 0.

As has been described above, before variables which have been read out of the LMEM 112 or TMEM 114, are input, the rotater 113A rotates the variables with a rotate value corresponding to the shift value of the block. In the case of the memory controller 103 using the check matrix H3 of the block size 8, the maximum rotate value of the rotater 113A is “7” that is “block size−1”. If the quantifying bit number of reliability is “u”, the bit number of each variable is “u”. Thus, the input/output data width of the rotater 113A is “8×u” bits.

In the meantime, the memory (LMEM) that stores a logarithmic likelihood ratio (LLR), which represents the likelihood of data read out of the NAND flash memory by quantizing the likelihood by 5 to 6 bits, needs to have a memory capacity which corresponds to a code length×a quantizing bit number. From the standpoint of optimization of cost, the LMEM functioning as a large-capacity memory is necessarily implemented with a static RAM (SRAM). Accordingly, the arithmetic algorithm and hardware of the LDPC decoder for a NAND flash memory are optimized, in general, on the presupposition of the LMEM that is implemented with an SRAM. As a result, a unit block base parallel method, in which the LLRs are accessed by sequential addresses, is generally used.

However, the unit block base parallel method has a complex arithmetic algorithm, and requires a plurality of rotaters of large-scale logics (large-scale wiring areas). The provision of plural rotaters poses a problem in increasing the degree of parallel processing and the processing speed.

### (Unit Block Base Parallel Method)

Referring to FIG. 6, FIG. 7 and FIG. 8, a unit block base parallel method is described. In order to simplify the description, it is assumed that a check matrix is one row×three columns, a block size is 4×4, a code length is 12 bits (hereinafter, the code length is referred to as “frame length”), and four check nodes cn (also referred to simply as “cn”) are provided per row. In addition, it is assumed that the row weight is “3” and the column weight is “1”.

As illustrated in FIG. 6, LDPC frame data, which has been read out of a NAND flash memory (not shown), is divided with a unit block size from the beginning of a frame, that is, with four bits, and delivered to an LLR conversion table 11. In the LLR conversion table 11, the converted logarithmic likelihood ratio data (LLR) is stored in an LMEM 12.

An arithmetic module 13 reads LLRs of unit blocks from the LMEM 12, executes an arithmetic operation on the LLRs, and writes the LLRs back into the LMEM 12. There are provided arithmetic modules 13 corresponding to the unit block size (i.e. corresponding to four variable nodes (hereinafter also referred to simply as “vn”). In this example, the frame length is 12 bits and is short. However, for example, if the frame length increases to as large as 10 Kbits, because of the address management of the LMEM 12, such an architecture is adopted that LLRs of variable nodes vn with sequential addresses are accessed together from the LMEM 12 and the accessed LLRs are subjected to arithmetic operations. When the LLRs of variable nodes vn with sequential addresses are accessed together, the LLRs are accessed in units of a base block and processing is executed (“unit block parallel method”). At this time, in order to programmably select 4 variable nodes vn belonging to a basic block connected to a check node cn, the above-described rotater is provided.

The rotater includes a function of arbitrarily selecting four 6-bit LLRs with respect to a certain check node cn, if the quantizing bit number is 6 bits. Since the block size of an actual product is, e.g. 128×128 to 256×256, the circuit scale and wiring area of the rotater become enormous.

FIG. 7 illustrates a process flow of the unit block base parallel method. As illustrated in FIG. 7, the unit block base parallel method is executed by dividing the row process and column process into 2 loops. In loop 1, β is found by subtracting a previous α from the LLR that is read out of the LMEM 12, a minimum α1 and a next minimum α2 are found from β connected to the same check node cn, and these are temporarily stored in the TMEM. In addition, β which has been found in loop 1 is once written back into the LMEM. Parallel processes are executed for four vn at a time, and the parallel processing is repeatedly executed three times, which correspond to the row weight, in the process of one row. Thereby, α1 and α2 are calculated.

In loop 2, β is read out from the LMEM 12, α1 and α2, which have been calculated in loop 1, are added to the read-out β, and the resultant is written back to the LMEM 12 as a new LLR. This operation is executed in parallel for four vn at a time, and the parallel processing is repeatedly executed three times for the process of one row. Thereby, the update of LLRs of all vn is completed.

By executing the processes of the loop 1 and loop 2 for one row, one iteration (hereinafter also referred to as “ITR”) is finished. At a stage at which 1 ITR is finished, if the parity of all check nodes cn passes, the correction process is successfully finished. If the parity is NG, the next 1 ITR is executed. If the parity fails to pass even if ITR is executed a predetermined number of times, the correction process terminates in failure.

FIG. 8 illustrates an example of a procedure for updating LLRs of variable nodes vn.

Row processes of vn0, 1, 2 and 3 belonging to column block 0 (calculation of β, α1 and α2 and parity check of cn0, 1, 2, 3)

(1) Row process of vn4, 5, 6, 7 belonging to column block 1.
(2) Row process of vn8, 9, 10, 11 belonging to column block 2.
(3) Column process of vn0, 1, 2, 3 belonging to column block 0 (LLR update).
(4) Column process of vn4, 5, 6, 7 belonging to column block 1.
(5) Column process of vn8, 9, 10, 11 belonging to column block 2.

The processing efficiency of the above-described unit block parallel method is low, since LLR update processes for all vn are not completed unless the column process and row process are executed by different loops. The essential reason for this is that a retrieval process of the LLR minimum value of variable nodes vn belonging to a certain check node, and a retrieval process of the next minimum value cannot be executed at the same time as the LLR update process. As a result, the circuit scale increases, the power consumption increases, and the cost performance deteriorates.

In addition, in order to access LLRs of vn of one block, it is necessary to access the large-capacity LMEM each time, and the power consumption by the LMEM 12 increases. Since the LMEM 12 is constructed by the SRAM, power is consumed not only at a time of write but also at a time of read.

Furthermore, since the LMEM 12 is read twice and written twice, power consumption increases.

Besides, an LDPC decoder circuit for a multilevel (MLC) NAND flash memory, which stores data of plural bits in one memory cell, is designed on the presupposition of a defective model in which a threshold voltage of a cell shifts. Thus, such an error (hereinafter referred to as “hard error (HE)”) is not assumed that a threshold voltage shifts beyond 50% of an interval between threshold voltages, or a threshold voltage shifts beyond a distribution of neighboring threshold voltages. If such defects occur frequently, the correction capability lowers. The reason for this is that since a threshold voltage at a time of read does not necessarily exist near a boundary of a determination area, such a case occurs that the logarithmic likelihood ratio absolute value (|LLR|), which is the index of likelihood of a determination result of the threshold voltage, increases, despite the data read being erroneous.

### First Embodiment

In a first embodiment, the efficiency of an arithmetic process is improved, cost performance is improved, and degradation of correction capability by a hard error is improved.

The first embodiment relates to an LDPC decoder circuit for a NAND flash memory, which includes a memory (LMEM) which stores logarithmic likelihood ratio conversion data (LLR) of LDPC frame data. A check matrix is composed of M*N unit blocks with M rows and N columns. The LDPC decoder circuit includes a process unit for pipeline-processing an LLR update process (vn process of cn base) of variable nodes vn which are connected to a selected check node cn. The LDPC decoder circuit further includes a process unit for parallel-processing vn processes of a cn base of some check nodes cn. At a time of parallel processing, vn processes per 1 cn can be executed by one cycle.

FIG. 9 to FIG. 13 illustrate the first embodiment. The check matrix is the same as described above. The check matrix is 1 row×3 columns, and a block size is 4×4. 4 check nodes cn are provided per row. The row weight is “3”, and the column weight is “1”.

FIG. 9 illustrates an operation of the first embodiment. A parallel processing method (also referred to as “cn base parallel processing method”) of a plurality of variable nodes vn based on a check node cn according to the first embodiment is characterized by simultaneous execution of a row process and a column process in a single loop. In the example shown in FIG. 8, LLRs of variable nodes vn with sequential addresses are read out of the LMEM 12.

On the other hand, in the first embodiment, all variable nodes vn, which are connected to a check node cn, are simultaneously read out. Specifically, LLRs of variable nodes vn, which are connected to a check node cn belonging to i=1 row, are read out of the LMEM, and a matrix process is executed. Specifically, a 3 arithmetic operation and an a arithmetic operation are simultaneously executed (step S11, S12). Then, the value of row “i” is incremented, and the process of step S12 is executed for all the number of rows (step S13, S14, S12).

The present embodiment differs from the example of FIG. 8 with respect to the structure of the LMEM 12, since all variable nodes vn, which are connected to the check node cn, are simultaneously read out.

FIG. 10 illustrates a concept of the LMEM 12 of the present embodiment.

As illustrated in FIG. 10, the LMEM 12 is composed of, for example, three modules, or a memory having three ports. In this case, independent addresses of three systems can be input to the LMEM 12, and three unique variable nodes vn can be accessed. For example, LLRs of 3 vn are simultaneously read out of the LMEM 12.

In the case where the LMEM 12 is composed of a single module, as shown in FIG. 8, the storage addresses of variable nodes vn on the LMEM 12 become non-sequential. By contrast, in the case where the LMEM 12 is composed of three modules or a memory having three ports, as shown in FIG. 10, independent addresses of three systems can be input to the LMEM 12, and three unique variable nodes vn can be accessed. As illustrated in FIG. 10, the update procedure of vn is as follows.

(1) A matrix process (LLR update) of vn0, 5, 10 connected to cn0
(2) A matrix process (LLR update) of vn1, 6, 11 connected to cn1
(3) A matrix process (LLR update) of vn2, 7, 8 connected to cn2
(4) A matrix process (LLR update) of vn3, 4, 9 connected to cn3.

With substantially the same circuit scale as in the prior art, about 1.5 times to 2 times higher speed can be achieved, and the cost performance can greatly be improved.

In the meantime, the decoding algorithm of the first embodiment becomes the same as in the example of FIG. 8, for the following reason.

In the case of the first embodiment, the order of update of LLRs is different from the example of FIG. 8, but the first embodiment is the same as the prior art in that the update of all LLRs is finished at a stage when the row process/column process for one row has been finished.

Specifically, as illustrated in FIG. 8, in the case where the check matrix is formed by a unit block method, a certain variable node vn is never connected to plural check nodes cn in a single row. Thus, there occurs no row process using an LLR which has just been updated during the processing of a certain row.

FIG. 11 schematically shows the structure of the LDPC decoder according to the first embodiment. In FIG. 11, LLRs of a plurality of variable nodes, which are connected to one check node, are processed. FIG. 11 illustrates an example of implementation in which the degree of parallel processing is “1” (cp=1).

In FIG. 11, an LDPC decoder 21 includes a plurality of LMEMs 12-1 to 12-n, a plurality of arithmetic units 13-1 to 13-m, a row-directional logic circuit 14, a column-directional logic circuit 15 which controls these components, and a data bus control circuit 32. The row-directional logic circuit 14 includes a minimum value detection circuit 14-1, and a parity check circuit 14-2. The column-directional logic circuit 15 includes a memory 15-1 and an intermediate-value memory controller 15-2.

The LMEMs 12-1 to 12-n are configured as modules for respective columns. The number of LMEMs 12-1 to 12-n, which are disposed, is equal to the number of columns. The LMEMs 12-1 to 12-n are implemented, for example, as registers, and each of the LMEMs 12-1 to 12-n is composed with, for example, a block size×6 bits.

The arithmetic units 13-1 to 13-m are arranged in accordance with not the number of columns but the row weight number m. The number of blocks (non-zero blocks), in which a shift value is not “0”, corresponds to the row weight number. Specifically, since the LLR of one variable node vn is read out from one non-zero block, it should suffice if the number of arithmetic units is m.

The data bus control circuit 32 executes dynamic allocation as to which of LLRs of variable nodes vn of column blocks is to be taken into which of the arithmetic units 13-1 to 13-m, according to which of the sequentially ordered rows is to be processed by the arithmetic units 13-1 to 13-m. By this dynamic allocation, the circuit scale of the arithmetic units 13-1 to 13-m can be reduced.

The column-directional logic circuit 15 includes, for example, a controller 15-1, an intermediate value memory such as TMEM 15-2, and a memory 15-3. The controller 15-1 controls the operation of the LDPC decoder 21, and is composed of a sequencer.

The intermediate value memory (TMEM) 15-2 stores intermediate value data, for instance, α (α1, α2) of ITR, a sign of α of each vn (sign information of α, which is added to all vn connected to check node cn), INDEX, and a parity check result of each check node cn. Incidentally, the α sign of each vn will be described later.

The memory 15-3 stores, for example, a check matrix or an LLR conversion table (to be described later).

The controller 15-1 delivers vn addresses to the LMEM 12-1 to LMEM 12-n in accordance with a block shift value. Thereby, LLRs of variable nodes vn corresponding to the weight number of the row, which is connected to the check node cn, can be read out from the LMEM 12-1 to LMEM 12-n.

The minimum value detection circuit 14-1, which is provided in the row-directional logic circuit 14, retrieves, from the arithmetic results of the arithmetic units 13-1 to 13-m, the minimum value and next minimum value of the absolute values of the LLRs connected to the check node cn. The parity check circuit 14-2 checks the parity of the check node cn. The LLRs of all variable nodes vn, which are connected to the read-out check node cn, are supplied to the minimum value detection circuit 14-1 and parity check circuit 14-2.

The arithmetic units 13-1 to 13-m generate β (logarithmic likelihood ratio) by calculation using the LLR data read out of the LMEMs 12-1 to 12-n, an intermediate value, for instance, α (α1 or α2) of the previous ITR, and the sign of a of each vn, and further calculates updated LLR′ from the generated β and the intermediate value (output data α of the minimum value detection circuit 14-1 and the cn parity check result). The updated LLR′ is written back to the LMEMs 12-1 to 12-n.

FIG. 12 concretely illustrates the LDPC decoder 21 shown in FIG. 11. FIG. 12 shows a structure for executing matrix parallel processing by a pipeline configuration. The same components as those in FIG. 11 are denoted by like reference numerals.

Data, which has been read out of a NAND flash memory (not shown), is delivered to a data buffer 30. This data is data to which parity data is added, for example, in units of a frame, by an LDPC encoder (not shown). The data stored in the data buffer 30 is delivered to an LLR conversion table 31. The LLR conversion table 31 converts the data, which has been read out of the NAND flash memory, to logarithmic likelihood ratio data. The data, which has been output from the LLR conversion table 31, is supplied to the LMEMs 12-1 to 12-n.

The LMEMs 12-1 to 12-n are connected to first input terminals of β arithmetic circuits 13a, 13b and 13c via the data bus control circuit 32. The data bus control circuit 32 is a circuit which executes dynamic allocation, and executes control as to which of LLRs of variable nodes vn of column blocks is to be supplied to which of the arithmetic units.

The β arithmetic circuits 13a, 13b and 13c constitute parts of the arithmetic units 13-1 to 13-m. In the case of the example shown in FIG. 10, since the number of weights used in each row process is three, it should suffice if the number of arithmetic units is three. Second input terminals of the β arithmetic circuits 13a, 13b and 13c are connected to the TMEM 15-2 via a register 33.

The TMEM 15-2 stores intermediate value data, for instance, α1 and α2 of the previous ITR, a sign of a of each variable node vn, INDEX, and a parity check result of each check node cn.

The β arithmetic circuits 13a, 13b and 13c execute arithmetic operations between the LLR data, which is supplied from the LMEMs 12-1 to 12-n, and the intermediate value data which is supplied from the TMEM 15-2.

Output terminals of the β arithmetic circuits 13a, 13b and 13c are connected to a first β register 34. The first β register 34 stores output data of the β arithmetic circuits 13a, 13b and 13c.

Output terminals of the first β register 34 are connected to the minimum value detection circuit 14-1 and parity check circuit 14-2. Output terminals of the minimum value detection circuit 14-1 and parity check circuit 14-2 are connected to the TMEM 15-2 via a register 35.

FIG. 12 illustrates the case in which the minimum value detection circuit 14-1 and parity check circuit 14-2 are implemented in parallel to the first β register 34, but the configuration is not limited to this example. The minimum value detection circuit 14-1 and parity check circuit 14-2 may be in series to the first β register 34. In the case where the minimum value detection circuit 14-1 and parity check circuit 14-2 are implemented in parallel, a circuit configuration is implemented such that the processes of these components are executed in several clocks (e.g. 1 to 2 clocks).

The output terminals of the first β register 34 are connected to one-side input terminals of LLR′ arithmetic circuits 13d, 13e and 13f via a second β register 36 and a third β register 37. The second β register 36 stores output data of the first β register 34, and the third β register 37 stores data of the second β register 36.

The second β register 36 and third β register 37 are disposed in accordance with the number of stages of the pipeline which is constituted by the minimum value detection circuit 14-1, parity check circuit 14-2 and register 35. FIG. 12 illustrates a circuit configuration in a case where the process of the minimum value detection circuit 14-1 and parity check circuit 14-2 is executed with one clock. When the number of clocks is 2, and additional β register is needed.

The LLR′ arithmetic circuits 13d, 13e and 13f constitute parts of the arithmetic units 13-1 to 13-m, and are composed of three arithmetic circuits, like the β arithmetic circuits 13a, 13b and 13c. The other-side input terminals of the LLR′ arithmetic circuits 13d, 13e and 13f are connected to an output terminal of the register 35.

The LLR′ arithmetic circuits 13d, 13e and 13f execute an arithmetic operation between the data β, which is output from the third β register 37, and the intermediate value which is supplied from the register 35, and output updated LLR's.

First output terminals of the LLR′ arithmetic circuits 13d, 13e and 13f are connected to input terminals of an LLR′ register 39, and second output terminals thereof are connected to the TMEM 15-2 via a register 38.

The LLR′ register 39 stores updated LLR's which are output from the LLR′ arithmetic circuits 13d, 13e and 13f. Output terminals of the LLR′ register 39 are connected to the LMEMs 12-1 to 12-n.

The register 38 stores INDEX data which is output from the LLR′ arithmetic circuits 13d, 13e and 13f. The register 38 is connected to the TMEM 15-2.

The above-described LMEMs 12-1 to 12-n, the β arithmetic circuits 13a, 13b and 13c functioning as first arithmetic modules, the first β register 34, the register 35, the second β register 36, the third β register 37, the LLR′ arithmetic circuits 13d, 13e and 13f functioning as second arithmetic modules, and the LLR′ register 39 are included in each stage of the pipeline, and these circuits are operated by clock signals (not shown).

FIG. 13 is a view illustrating an operation of the LDPC decoder 21 shown in FIG. 12, and illustrates an example of execution of a 1-clock cycle.

The LDPC decoder 21 executes, in a 1-row process, processes of check nodes cn, the number of which corresponds to the block size number. To begin with, LLR data of variable nodes vn is read out of the LMEMs 12-1 to 12-n, a matrix process is executed on the LLR data, and the content of the LLR data is updated. The updated LLR data is written back to the LMEMs 12-1 to 12-n. This series of processes is successively executed on the plural check nodes cn by a pipeline. In this embodiment, 1-row blocks are processed by five pipeline states.

Next, referring to FIG. 13, the process content in each stage is described.

FIG. 13 illustrates that the LDPC decoder 21 is composed of first to fifth stages, and in each stage the row process of each of check nodes cn0 to cn3 is executed by one clock.

### (First Stage)

To start with, LLR data is read out of the LMEMs 12-1 to 12-n. Specifically, LLR data of variable nodes vn, which are connected to a selected check node cn, is read out of the LMEMs 12-1 to 12-n. In the case of the present embodiment, three LLR data are read out of the LMEMs 12-1 to 12-n.

Further, intermediate value data is read out of the TMEM 15-2. The intermediate value data includes α1 and α2 of the previous ITR, the sign of a of each variable node vn, INDEX, and a parity check result of each check node cn. The intermediate value data is stored in the register 33. In this case, α is probability information from a check node to a bit node and is indicative of an absolute value of β in the previous ITR, α1 is a minimum value of the absolute value, and α2 is a next minimum value (α1<α2). INDEX is an identifier of a variable node vn having a minimum absolute value of β.

### (Second Stage)

The β arithmetic circuits 13a, 13b and 13c, which function as first arithmetic modules, execute arithmetic operations between the LLR data from the LMEMs 12-1 to 12-n and the intermediate value data which has been read out of the TMEM 15-2, thereby calculating β (logarithmic likelihood ratio). Specifically, each of the β arithmetic circuits 13a, 13b and 13c executes an arithmetic operation of β=(LLR data)−(intermediate value data). In this arithmetic operation, with respect to a certain variable node vn, if the absolute value of β is minimum in the previous ITR, the next minimum value α2 is subtracted from β, and if the absolute value of β is not minimum, the minimum value α1 is subtracted from β. Incidentally, the sign of the intermediate value data is determined by the sign of a for each vn.

The results of the arithmetic operations of the β arithmetic circuits 13a, 13b and 13c are stored in the first β register 34.

### (Third Stage)

The minimum value detection circuit 14-1 calculates, from the arithmetic operation result β stored in the first β register 34, the minimum value al of the absolute value of β, the next minimum value α2, and the identifier INDEX of a variable node vn having a minimum absolute value of β. In addition, the parity check circuit 14-2 executes a parity check of all check nodes cn.

The detection result of the minimum value detection circuit 14-1 and the check result of the parity check circuit 14-2 are stored in the register 35.

In addition, when the minimum value detection circuit 14-1 and parity check circuit 14-2 execute processes and the results of the processes are stored in the register 35, the data of the first β register 34 is successively transferred to the second β register 36 and a third β register 37.

### (Fourth Stage)

Based on the check result of the parity check circuit 14-2, the LLR′ arithmetic circuits 13d, 13e and 13f functioning as second arithmetic modules execute arithmetic operations of the arithmetic operation result β, which is stored in the third β register 37, and the detection result which has been detected by the minimum value detection circuit 14-1, and generate updated LLR′ data. Specifically, the LLR′ arithmetic circuits 13d, 13e and 13f execute LLR′=β+intermediate value data (α1 or α1 calculated in stage 3). Furthermore, the LLR′ arithmetic circuits 13d, 13e and 13f generate the sign of α of each variable node vn. The generation of the sign of α of each vn is generated as follows.

If the LLR code is “0” and the result of the parity check of the check node cn is OK, β+α is calculated and the sign of α of each vn becomes “0”.

If the LLR code is “0” and the result of the parity check of the check′ node cn is NG, β−α is calculated and the sign of α of each vn becomes “1”.

If the LLR code is “1” and the result of the parity check of the check node cn is OK, β−α is calculated and the sign of α of each vn becomes “1”.

If the LLR code is “1” and the result of the parity check of the check node cn is NG, β+α is calculated and the sign of a of each vn becomes “0”.

The sign of a of each vn is stored in the register 38.

Along with the above-described operation, the intermediate value data stored in the register 35 (α1, α2, INDEX data, and the parity check result of each check node cn), and the sign of α of each vn stored in the register 38 is written in the TMEM 15-2.

### (Fifth Stage)

The LLR′ data updated by the LLR′ arithmetic circuits 13d, 13e and 13f is stored in the LLR′ register 39, and the data stored in the LLR′ register 39 is written in the LMEMs 12-1 to 12-n.

In the case of the architecture shown in FIG. 6 and FIG. 7, β calculated in the row process of loop 1 is written back to the LMEM, and the β is read out again from LMEM in the column process of loop 2, and the updated LLR′ is calculated. If an intermediate buffer, which temporarily stores β, is disposed outside the LMEM, the capacity of the intermediate buffer becomes substantially equal to that of the LMEM, and the circuit scale increases. Thus, β calculated in loop 1 is once written back to the LMEM. As a result, in the case of the architecture shown in FIG. 6 and FIG. 7, it is necessary to read the LMEM twice and write the LMEM twice, leading to an increase in access to the LMEM.

By contrast, according to the first embodiment, it should suffice if the capacity of each of the first β register 34, second β register 36 and third β register 37, which function as buffers for temporarily storing β, is such a capacity as to correspond to the number of variable nodes vn which are connected to the check node cn. Accordingly, the capacity of each of the first β register 34, second β register 36 and third β register 37 can be reduced.

Moreover, according to the first embodiment, since the first, second and third β registers 34, 36 and 37, which temporarily store β are provided, accesses to the LMEMs 12-1 to 12-n can be halved to one-time read and one-time write. Therefore, the power consumption can greatly be reduced.

Besides, since the accesses to the LMEMs 12-1 to 12-n are halved, it is possible to avoid butting of accesses to the LMEMs 12-1 to 12-n in the pipeline process in the same row process. Thus, the apparent execution cycle number per 1 cn can be set at “1” (1 clock), and the processing speed can be increased.

Furthermore, the minimum value detection circuit 14-1 and parity check circuit 14-2 are implemented in parallel in the third stage, and the minimum value detection circuit 14-1 and parity check circuit 14-2 are operated in parallel. Thus, for example, with 1 clock, the detection of the minimum value and the parity check can be executed.

### Second Embodiment

FIG. 14 and FIG. 15 illustrate a second embodiment, and the same parts as in the first embodiment are denoted by like reference numerals.

The LDPC decoder shown in the first embodiment can flexibly select the degree of parallel processing of the circuits which are needed for arithmetic operations of the check nodes cn, in accordance with the required capability.

FIG. 14 and FIG. 15 illustrate an example in which the parallel processing degree of check nodes cn is set at “2” (cp=2). In this case, two check nodes cn are selected at the same time, and the LLRs of the variable nodes, which are connected to each check node cn, are processed at the same time. Thus, the number of modules of the LMEMs 12-1 to 12-n is double the number of column blocks, and also there are provided double the number of modules of the arithmetic units 13-1 to 13-m and the row-directional logics 14 including the minimum value detection circuit 14-1 and parity check circuit 14-2.

In the meantime, it is possible to double the number of input/output ports of the LMEMs 12-1 to 12-n, instead of doubling the number of modules of the LMEMs 12-1 to 12-n.

According to the above-described second embodiment, since the parallel processing degree of check nodes cn is set at “2”, as illustrated in FIG. 15, it is possible to process two check nodes cn in 1 clock. Thus, the number of process cycles of one row can be halved, compared to the first embodiment shown in FIG. 13, and the processing speed can be further increased.

Incidentally, the parallel processing degree of check nodes cn is not limited to “2”, and may be set at “3” or more.

### Third Embodiment

In the above-described first and second embodiments, in order to make the description simple, the check matrix is set to be one row. However, an actual check matrix comprises a plurality of rows, for example, 8 rows, and the column weight is 1 or more, for instance, 4.

Referring to FIG. 16 to FIG. 20, a description is given of control between row processes by the LDPC decoder 21 shown in FIG. 12.

FIG. 16 shows an example of the check matrix according to a third embodiment. In this example of the check matrix, the block size is 8×8, the number of row blocks is 3, and the number of column blocks is 3.

FIG. 17, FIG. 18 and FIG. 20 illustrate a process of a column 0 block in a row 0 process and a row 1 process.

The LDPC decoder 21 updates LLR data which has been read out of the LMEMs 12-1 to 12-n, and writes the LLR data back to the LMEMs 12-1 to 12-n.

In the case where a process has been executed by the LDPC decoder 21 by using the check matrix shown in FIG. 16, when a process of row 0 transitions to a process of row 1, a read access to LLR of vn7 occurs in the process of row 1, before LLR data of a variable node vn7 is updated and written back in the process of row 0. In short, butting of access to vn occurs.

Specifically, in the check matrix shown in FIG. 16, if attention is paid to a column block 0, a row 0/column 0 block has a shift value “0”, and a row 1/column 0 block has a shift value “7”. In this state, as illustrated in FIG. 18, if the process of row 0 and the process of row 1 are successively executed, a read access to vn0 to vn3 is possible since the write of updated LLR′ has been completed. However, a read access to vn4 to vn7 is not possible since the write of updated LLR′ is not completed.

In this case, as illustrated in FIG. 17, the process of vn7 of row 1 may be started from the cycle next to the cycle in which LLR′ of vn7 of row 0 has been written in the LMEMs 12-1 to 12-n. In other words, idle cycles may be inserted between row processes. In the case of this example, 4 idle cycles are inserted between the process of row 0 and the process of row 1.

In this manner, by inserting idle cycles between row processes, butting of vn access can be avoided.

On the other hand, as illustrated in FIG. 17, even without inserting idle cycles between row processes, butting of vn access can be avoided by adjusting block shift values when the check matrix is designed.

For example, the block shift values of the check matrix shown in FIG. 16 are adjusted as in a check matrix shown in FIG. 19. Thereby, the vn access butting can be avoided without inserting idle cycles between row processes. In the case of the check matrix shown in FIG. 19, the shift values of blocks in a part indicated by a broken line are made different from those in the check matrix shown in FIG. 16.

FIG. 20 illustrates a row process according to the check matrix shown in FIG. 19. In this manner, by varying the shift values of the check matrix, the vn access butting can be avoided without inserting idle cycles between row processes, since the write of vn3 of row 0 has been completed when vn3 of row 1 is accessed.

According to the above-described third embodiment, by inserting idle cycles between row processes or by adjusting the shift values of the check matrix, the butting of variable node vn access in the LMEMs 12-1 to 12-n can be avoided.

### Fourth Embodiment

FIG. 21, FIG. 22 and FIG. 23 illustrate a fourth embodiment, and the same parts as in the first embodiment are denoted by like reference numerals. FIG. 21 shows an example of the LDPC decoder according to the fourth embodiment. FIG. 22 shows an example of the check matrix. FIG. 23 is a flowchart illustrating the operation of the fourth embodiment.

In the fourth embodiment, LDPC correction is made with a plurality of decoding algorithms by using a result of parity check.

In the fourth embodiment, for example, when decoding is executed with a Mini-SUM algorithm, LLR is updated by making additional use of bit flipping (BF). Correction is made with a plurality of algorithms by using an identical parity check result detected from an intermediate value of LLR. Thereby, the capability can be improved without lowering an encoding ratio or greatly increasing the circuit scale.

Next, the fourth embodiment is described with reference to FIG. 21, FIG. 22 and FIG. 23.

In the LDPC decoder 21 shown in FIG. 21, a flag register 41 is connected to the parity check circuit 14-2. The flag register 41 is connected to the LLR′ arithmetic circuits 13d, 13e and 13f.

When the parity check circuit 14-2 has executed parity check of check nodes cn, the flag register 41 stores a parity check result of the check nodes cn as a 1-bit flag (hereinafter also referred to as “parity check flag”) with respect to each variable node vn.

As shown in FIG. 22, in the present embodiment, the check matrix has a block size 8×8, three row blocks, three column blocks, and a column weight “3”. Thus, one variable node vn is connected to three check nodes cn, and a three-time parity check result is stored in the flag register 41 as a 1-bit flag.

As illustrated in FIG. 23, each time a 1-row block process is executed, parity check of a check node cn is executed. If the parity check fails to pass, a flag is set at “1” in the flag register 41. If the parity check passes, the flag of the flag register 41 is cleared to “0”. Specifically, in the case where the flag of a certain variable node vn is “1” at a time when a three-row block process, that is, 1 ITR, has been finished, this variable node vn indicates that the parity check of the check node cn failed to pass three times (S41).

For example, in the check matrix shown in FIG. 22, paying attention to a variable node vn0, when all parity checks of check nodes cn0, 13, 18, which are connected to the vn0, failed to pass, the parity check flag of the variable node vn0 is set at “1”.

In the second and subsequent ITR, the LLR′ arithmetic circuits 13d, 13e and 13f execute arithmetic processes in accordance with the parity check flag supplied from the flag register 41, with respect to each row block process (S42, S43).

Specifically, the LLR′ arithmetic circuits 13d, 13e and 13f execute, in addition to a normal LLR update process, a unique LLR correction process for, for example, a variable node vn with a parity check flag “1” (S44).

As the unique correction process, for example, a process according to a bit flipping (BF) algorithm is applied. Specifically, when all parity check results of three check nodes cn, which are connected to the variable node vn0, fail to pass, it is highly probable that the variable node vn0 is erroneous. Thus, correction is made in a manner to lower the absolute value of the LLR of the variable node vn0. To be more specific, the LLR′ arithmetic circuit 13d, 13e, 13f increases, by several times, the value of a which is supplied from the register 35, and updates the LLR by using this α. In this manner, the LLR of the variable node vn, which is highly probably erroneous, is further lowered.

In addition, the LLR′ arithmetic circuit 13d, 13e, 13f does not execute the unique correction process for the variable node vn with a parity check flag “0”.

The above-described unique correction process means that a single parity check is used in the LDPC decoder, and a decoding process is executed by using both the mini-sum algorithm and applied BF algorithm.

In the meantime, in the BF decoding that is one of decoding algorithms of LDPC, LLR is not used and only the parity check result of the check node cn is used. Thus, the BF decoding has a feature that it has a high tolerance to a hard error (HE) on data with an extremely shifted threshold voltage, which has been read out of a NAND flash memory. Therefore, the BF decoding process can be added to the LDPC decoder which determines the check node cn for which parallel processing is executed by the variable node vn base, as described above.

FIG. 24 illustrates a modification of the fourth embodiment.

As shown in FIG. 24, before the normal mini-sum decoding process illustrated in steps S11 to S14, the parity check of all check nodes cn and the update of the parity check flag are executed. In the final row process, if the parity check flag is “1”, the sign bit is BF decoded (bit inversion). According to this modification, the hard error tolerance of the LDPC decoder can be enhanced.

Incidentally, the BF decoding can be executed by using the arithmetic circuits for mini-sum as such. In the ordinary mini-sum arithmetic circuit, only the most significant bit (sign bit) of the LLR is input, and the calculation of β or the detection of the minimum value of β is not executed. It should suffice if the parity check of all check nodes cn and the update of the parity check flag are executed.

For example, as shown in FIG. 21, the sign inversion process is constituted by an inverter circuit 42 and selector 43 provided in the LLR′ arithmetic circuits 13d, 13e, 13f. Specifically, a sign bit, which is inverted by the inverter circuit 42, is supplied to a first input terminal of the selector 43, and a sign bit is supplied to a second input terminal of the selector 43. The selector 43 selects one of the inverted sign bit and the sign bit, which are supplied to the first and second input terminals, in accordance with the parity check flag supplied from the flag register 41, and outputs the selected one. With this structure, the sign inversion process can easily be implemented.

With the above-described fourth embodiment, too, the same advantageous effects as with the first embodiment can be obtained. Moreover, according to the fourth embodiment, check nodes cn, which are connected to the same variable node vn, are processed batchwise, and sequential processes in the row direction are also executed, and furthermore the LLR is updated with an addition of the bit flipping (BF) algorithm. In this manner, by correcting an error with use of plural algorithms, the capability can be improved without lowering an encoding ratio or greatly increasing the circuit scale.

In the BF decoding, LLR is not used, and only the parity check result of the check node cn is used. Thus, since the tolerance to data with an extremely shifted threshold voltage, which has been read out of a NAND flash memory, is high, it is possible to realize ECC of a multilevel (MLC) NAND flash memory which stores plural bits in one memory cell.

The LDPC decoders described in the first to fourth embodiments process data of NAND flash memories. However, the embodiments are not limited to this example, and are applicable to data processing in communication devices, etc.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An error correction circuit comprising:
a first memory module configured to store logarithmic likelihood ratio data to which low density parity check codes (LDPC) data has been converted;
a read-out module configured to read out, from the first memory module, the logarithmic likelihood ratio data of a plurality of variable nodes which are connected to a selected check node, based on a check matrix;
a first arithmetic module configured to calculate a plurality of second reliability data, based on the logarithmic likelihood ratio data, which is read out of the first memory module, of the plurality of variable nodes connected to the selected check node, and first reliability data;
a detector configured to detect a minimum value of the plurality of second reliability data;
a second arithmetic module configured to execute an arithmetic operation of the second reliability data and the minimum value which is output from the detector, the second arithmetic module being configured to output an arithmetic result as the logarithmic likelihood ratio data which has been updated; and
a transfer module configured to transfer the updated logarithmic likelihood ratio data, which is supplied from the second arithmetic module, to the first memory module.

2. The circuit according to claim 1, wherein the first memory module, the first arithmetic module, the detector, the second arithmetic module and the transfer module constitute stages of a pipeline.

3. The circuit according to claim 2, further comprising a check circuit configured to check parity of the plurality of second reliability data, output data of the check circuit being stored in a second memory module.

4. The circuit according to claim 3, further comprising a second memory module configured to store the minimum value as the first reliability data.

5. The circuit according to claim 4, wherein the check circuit and the detector are configured to operate with two clocks or less.

6. The circuit according to claim 1, wherein a parallel processing degree of the check node is set at “2” or more.

7. The circuit according to claim 1, wherein an idle cycle is provided between a row process and a column process of the check matrix.

8. The circuit according to claim 1, wherein the check matrix comprises M rows and N columns (M and N are natural numbers) and is composed of M×N unit blocks, and shift values are set such that accesses to the first memory module do not overlap between neighboring row blocks.

9. The circuit according to claim 4, further comprising a fourth register configured to store a flag in accordance with a check result which is supplied from the check circuit, the fourth register being configured to store the flag with respect to each of the variable nodes.

10. The circuit according to claim 9, wherein the second arithmetic module is configured to correct the logarithmic likelihood ratio data in accordance with data of the flag, which is supplied from the fourth register.

11. The circuit according to claim 10, wherein the second arithmetic module is a mini-sum arithmetic circuit, and the second arithmetic module is configured to execute bit flipping decoding before a mini-sum arithmetic operation.

12. The circuit according to claim 11, wherein the logarithmic likelihood ratio data includes a sign bit, and the second arithmetic module is configured to invert the sign bit in accordance with the data of the flag, which is supplied from the fourth register.

13. An error correction method comprising:
reading out, from a first memory module, logarithmic likelihood ratio data of a plurality of variable nodes which are connected to a selected check node, based on a check matrix;
calculating a plurality of second reliability data, based on the read-out plural logarithmic likelihood ratio data, and first reliability data;
detecting a minimum value of the plurality of second reliability data;
executing an arithmetic operation of the plurality of second reliability data and the minimum value; and
transferring a result of the arithmetic operation to the first memory module as the logarithmic likelihood ratio data which has been updated.

14. The method according to claim 13, wherein said reading-out the logarithmic likelihood ratio data, said calculating the plurality of second reliability data, said detecting the minimum value, said executing the arithmetic operation of the plurality of second reliability data and the minimum value, and said transferring the result of the arithmetic operation to the first memory module as the updated logarithmic likelihood ratio data are pipeline-processed.

15. The method according to claim 14, further comprising checking parity of the plurality of second reliability data.

16. The method according to claim 15, wherein said detecting the minimum value and said checking the parity are executed with two clocks or less.

17. The method according to claim 14, wherein a parallel processing degree of the check node is set at “2” or more.
